(19) United States
(12) Patent Application Publication
(10) Pub. No.: US 2026/0213879 A1
(43) Pub. Date: Jul. 23, 2026

(54) DYNAMIC SPECTRUM SHARING WITH DYNAMIC RATE MATCHING

(71) Applicant: Google LLC, MOUNTAIN VIEW, CA (US)

(72) Inventors: Jibing WANG, San Jose, CA (US); Erik STAUFFER, Sunnyvale, CA (US)

(21) Appl. No.: 19/143,260

(22) PCT Filed: Nov. 15, 2023
(86) PCT No.: PCT/US2023/079760

§ 371 Date: Jun. 25, 2025

Related U.S. Application Data
(60) Provisional application No. 63/435,437, filed on Dec. 27, 2022.

(51) Int. Cl. H04L 1/00; H04W 72/0446; H04W 72/0453; H04W 72/231; H04W 72/541

(52) U.S. Cl. CPC H04L 1/0067; H04W 72/0446; H04W 72/0453; H04W 72/231; H04W 72/541

(57) ABSTRACT

User equipment proximately located with two base stations operating using different radio access technologies determines whether to enable or disable rate matching of transmissions from its supporting base station. If rate matching is enabled, the user equipment receives transmissions from one of the base stations that avoids time-frequency resources used by the other base station to carry control signals. If rate matching is disabled, the user equipment receives transmissions from the one base station in the same time-frequency resources used by the other base station to carry control signals.

### BACKGROUND

Base stations operating in proximity require coordination to avoid UE transmissions to one base station from interfering with the other base station. Any particular radio access technology typically provides mechanisms for a base station to reduce interference caused to another base station using that same radio access technology. Proximately located base stations using different radio access technologies can also interfere with each other, and therefore proximately located base stations using different radio access technologies typically operate in different wireless frequency spectrum. This limits the available spectrum, and thus is undesirable. Dynamic Spectrum Sharing (DSS) improves upon this type of spectrum allocation and allows base stations using different radio access technologies to share a common radio frequency spectrum.

Some radio access technologies allocate control signals in fixed time-frequency resources, and therefore dynamic spectrum sharing between base stations employing different radio access technologies should limit interference in these fixed time-frequency resources. For example, LTE base stations transmit cell-specific reference signals (CRSs), which are used by user equipment (UEs) for cell search and initial acquisition, downlink channel quality measurements, and downlink channel estimation for coherent demodulation and detection. NR base stations employ rate matching to avoid allocating resources to their UEs in the fixed time-frequency resources carrying the CRSs for a neighboring LTE base station. NR base stations also employ rate matching to avoid allocating resources to their UEs in the fixed time-frequency resources carrying the Primary Synchronization Signal (PSS), the Secondary Synchronization Signal (SSS), and the Physical Broadcast Channel (PBCH) for a neighboring LTE base station.

Depending on the number of antenna ports used, CRS generates between 4.76% and 14.29% overhead in time-frequency resources for the LTE base station. Therefore, avoiding CRS-assigned resources limits the amount of shared spectrum available for the NR base station.

Thus, it would be desirable to address the spectrum inefficiency that can arise during DSS between base stations operating using different radio access technologies.

### SUMMARY

This disclosure provides techniques for more efficient use of wireless frequency spectrum for Dynamic Spectrum Sharing (DSS) by disabling rate matching when interference caused by transmissions from base stations, which operate using different radio access technologies, is below an interference threshold. A UE connected to a second base station initially determines whether a control signal transmitted by a first base station on fixed time-frequency resources, interferes with the UE's reception of transmissions from the second base station. If the interference is not large enough to prevent the UE from receiving transmissions from the second base station, the UE requests that the second base station transmit data to the UE without rate matching. The second base station confirms with the first base station that interference caused by transmissions from the second base station in the fixed time-frequency resources will likely not impact the UEs supported by the first base station from receiving the first base station's transmission of the control signal. If so, the second base station informs the UE that rate matching is disabled and transmits data to the UE in the same fixed time-frequency resource that the first base station uses to transmit the control signal.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-1C are conventional downlink frames carrying cell-specific reference signals (CRSs) based on the number of antenna ports.

FIGS. 2A-2C are signaling diagrams illustrating various signals exchanged for dynamic rate matching according to embodiments.

FIG. 3 is a flowchart illustrating a method performed by a UE for dynamic rate matching according to embodiments.

FIG. 4 is a flowchart illustrating a method performed by a base station for dynamic rate matching according to embodiments.

FIG. 5 is a flowchart illustrating a method performed by another base station to support dynamic rate matching by a base station according to embodiments.

FIG. 6 is a block diagram illustrating software and hardware of a UE and two base stations according to embodiments.

### DETAILED DESCRIPTION

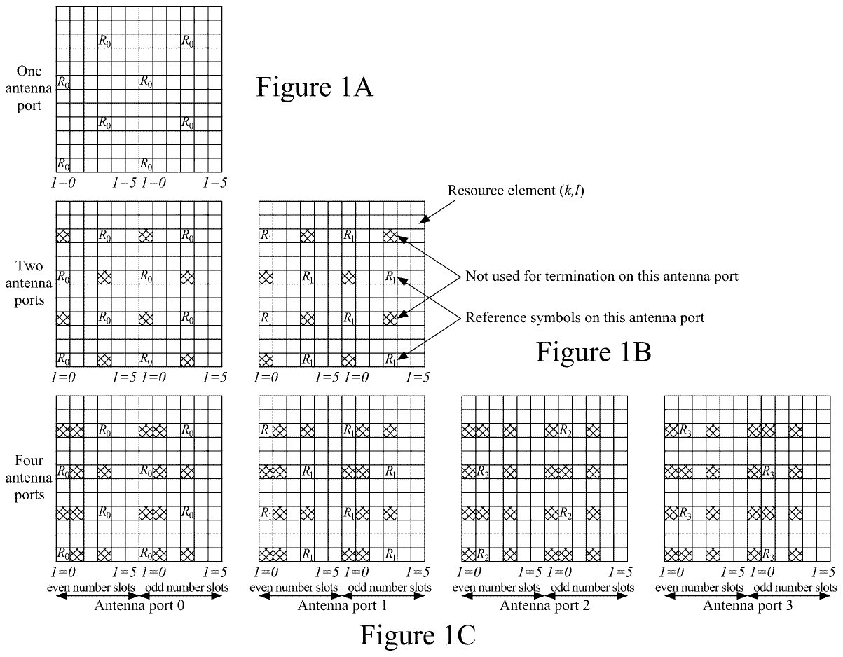

As described in the Background section, proximately-located base stations using different radio access technologies typically employ rate matching to minimize interference between the two base stations. Rate matching will now be described in connection with the downlink frames illustrated in FIGS. 1A-1C. FIG. 1A illustrates the time-frequency allocations (i.e., the resource elements) carrying the CRSs R₀ when a first base station employs one antenna port. FIG. 1B illustrates the time-frequency allocations carrying the CRSs R₀ and R₁ when a first base station employs two antenna ports. FIG. 1C illustrates the time-frequency allocations carrying the CRSs R₀, R₁, R₂, and R₃ when a first base station employs four antenna ports. A second base station, which uses a different radio access technology than the first base station, implements rate matching by not assigning the time-frequency resources for resource elements carrying the CRSs. As described in the Background section, avoiding the time-frequency resources carrying control signals, including the CRSs, the PSS/SSS, and the PBCH limits the number of resource elements that can be assigned by the second base station.

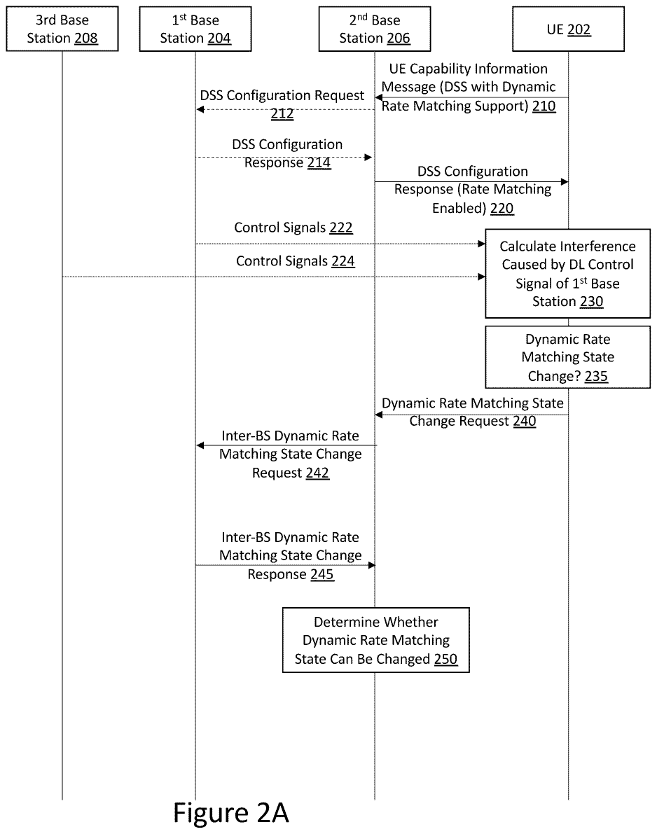

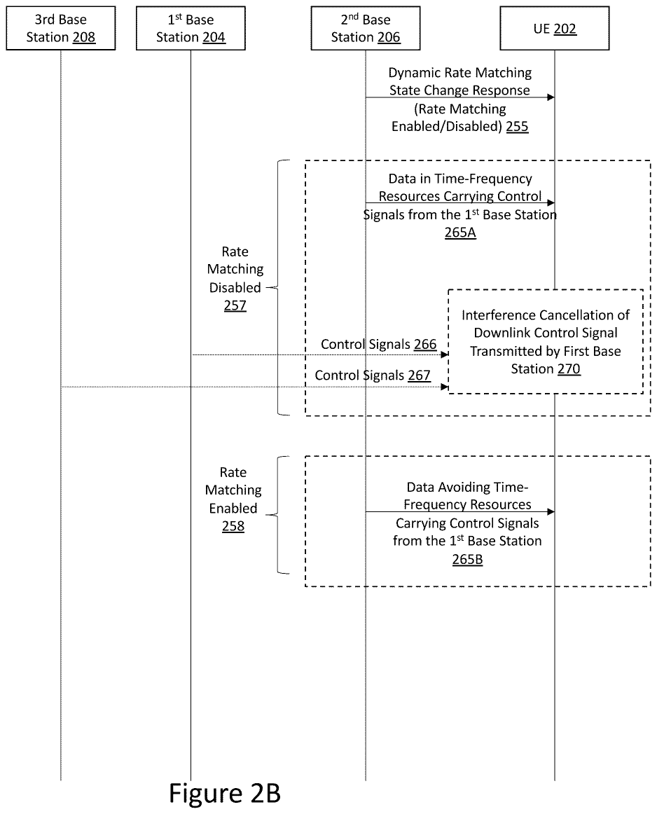

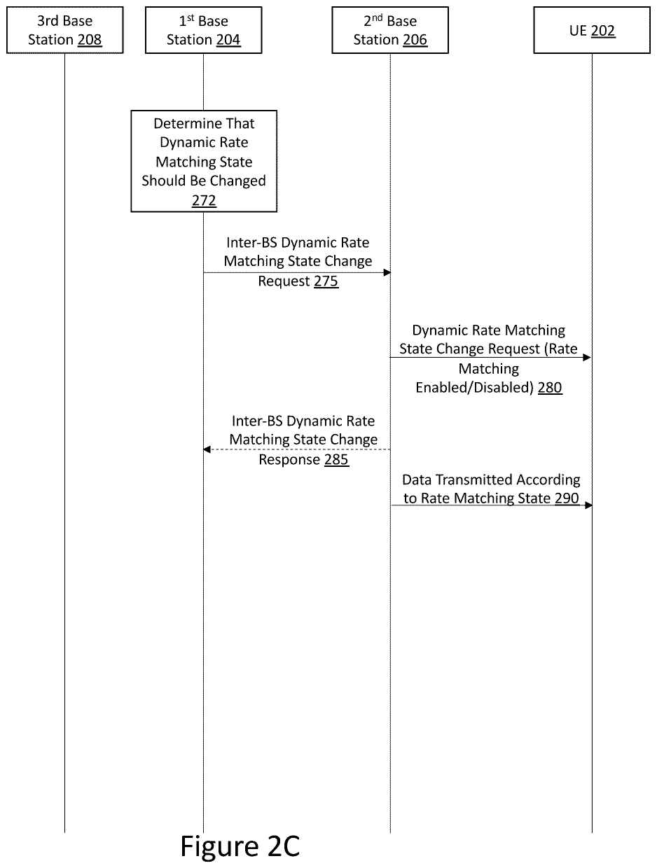

FIGS. 2A-6 illustrate a dynamic rate matching technique that supports allocation by the second base station 206 of the resource elements carrying control signals transmitted by the first base station 204. In one implementation, the control signals of concern are only the CRSs. Thus, in the discussion below when rate matching is disabled, the air interface resources used by the first base station 204 for CRSs can be allocated to the UE 202 by the second base station 206. However, the resources used by the first base station 204 for the PSS/SSS and PBCH are not allocated to the UE 202 by the second base station 206. In another implementation, the CRSs, PSS/SSS, and PBCH are the control signals of concern. Thus, in the discussion below when rate matching is disabled, the resources used by the first base station 204 for CRSs, PSS/SSS, and PBCH can be allocated to the UE 202 by the second base station 206.

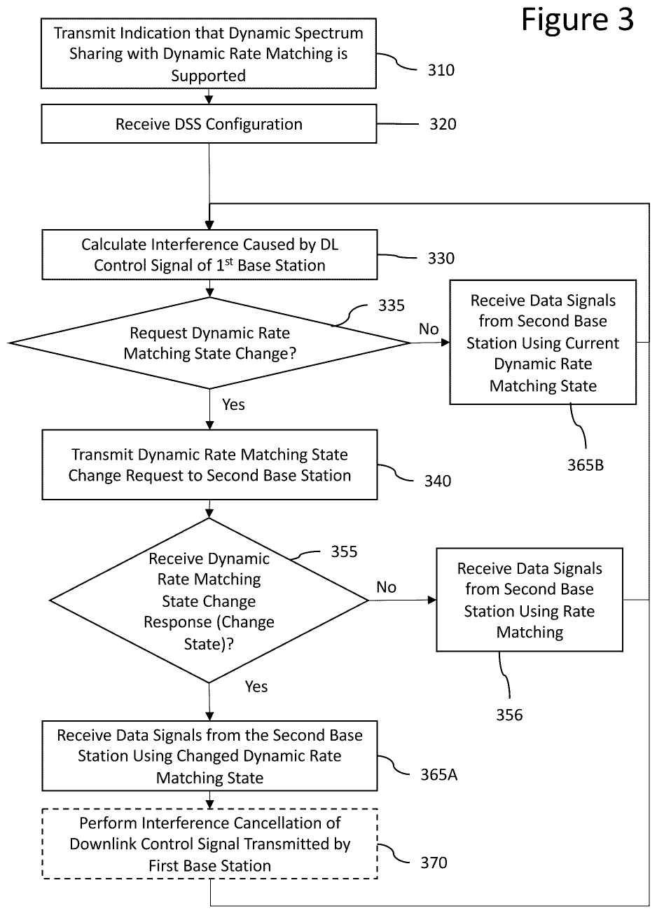

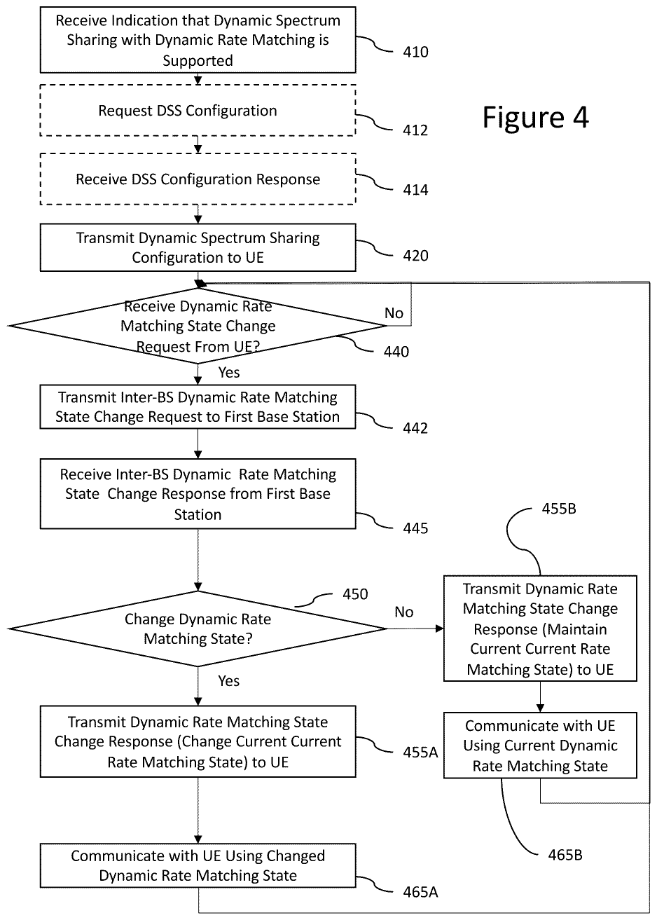

When a user equipment (UE) 202 initially connects with a second base station 206, the UE 202 transmits (step 310 of FIG. 3) a UE capability information message 210, which is received by the second base station 206 (step 410 of FIG. 4).

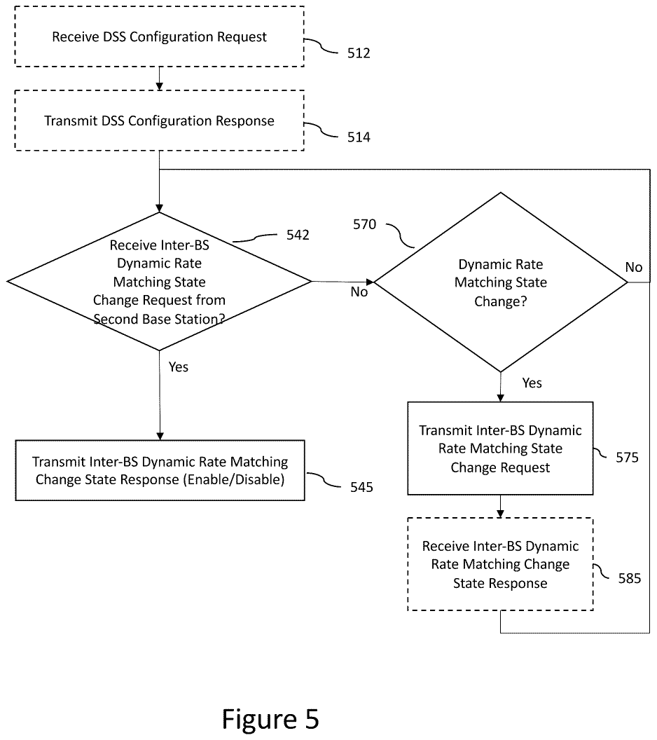

This message 210 can be transmitted, for example, using Radio Resource Control (RRC) or Medium Access Control (MAC) Control Element (CE) signaling. The UE capability information message 210 indicates that the UE 202 supports DSS with dynamic rate matching. The second base station 206 transmits a DSS configuration request message 212 (step 412), which is received by the first base station 204 (step 512 of FIG. 5). The first base station 204 then transmits (step 514) a DSS configuration response message 214, which is received by the second base station 206 (step 414). If the second base station 206 has already received the DSS configuration from the first base station 204, for example during the setup of a different UE, the DSS configuration request and response messages 212, 214 can be omitted at this stage.

The second base station 206, responsive to receiving an indication that the UE supports DSS with dynamic rate matching, transmits (step 420) a DSS configuration response message 220 indicating that rate matching is enabled, which is received by the UE 202 (step 320). The UE 202 then receives control signals 222, i.e., on the CRS resources illustrated in FIG. 1, from the first base station 204 and calculates 230 (step 330) interference caused by the control signals transmitted by the first base station 204 to transmissions from the second base station 206. This calculation can be based on any type of signal quality measurement, such as a signal-to-noise (SNR) ratio, a signal to interference and noise ratio (SINR), channel quality indicator (CQI), and/or Reference Signal Received Power (RSRP)/Reference Signal Received Quality (RSRQ) measurements.

The UE 202 then determines 235 (step 335) whether to change the dynamic rate matching state. The dynamic rate matching state is either that rate matching is enabled or rate matching is disabled. This determination can involve comparing the calculated interference received on the CRS resources to a predetermined interference threshold. The UE 202 can alternatively compare the SINR with an SINR threshold to determine whether the CRS resources transmitted by the first base station 204 will impact the UE's decoding performance. Other versions may compare the RSRP received on the CRS resources to a predetermined RSRP threshold or compare a weighted combination of signal measurement values received on the CRS resources to a predetermined threshold. Additionally, the UE 202 can perform CRS interference cancellation to mitigate the impact of the CRS resources transmitted by the first base station 204, and the determination can account for this interference cancellation. If the UE 202 determines that the dynamic rate matching state should not be changed (“No” path out of decision step 335), then the UE continues to receive (step 365B) transmissions from the second base station 206 using rate matching. Further, the UE 202 may periodically or aperiodically (e.g., event-driven) calculate 230 (step 330) the interference caused by the downlink control signals 222 of the first base station.

If the UE 202 determines 235 that the dynamic rate matching state should be changed (“Yes” path out of decision step 335), the UE 202 transmits (step 340) a dynamic rate matching state change request message 240, which is received by the second base station (step 440). The second base station 206 transmits (step 442) an inter-base station dynamic rate matching state change request message 242, which is received (step 542) by the first base station 204. The first base station 204 transmits (step 545) an inter-base station dynamic rate change response message 245, which is received (step 445) by the second base station 206. The inter-base station dynamic rate change response message 245 indicates whether or not the dynamic rate matching state can be changed (steps 445 and 545). This can be based, for example, on the transmission power of the control signals transmitted by the first base station 204, the loading of the first base station 204, etc. Alternatively, this can be based on the loading of the first base station 204 and its supported UE's reported RSRP/RSRQ/CQI to determine whether the second base station's 206 transmissions are interfering with the first base station's 204 transmissions to its supported UEs.

The second base station 206 determines 250 (step 450) whether the dynamic rate matching state can be changed. This determination can involve a comparison of a signal measurement reported to the second base station 206 by the UE 202 to an interference threshold. Further, if the comparison indicates that the signal measurement meets the threshold criterion, the second base station may determine 206 whether beamforming reduces the signal measurement below the interference threshold. This can involve the second base station 206 implementing beamforming and receiving another signal measurement from the UE 202 to compare with the interference threshold.

As shown in FIG. 2B, the second base station 206 then transmits (step 455A or 455B) a dynamic rate matching state change response message 255, which is received (step 355) by the UE 202. The dynamic rate matching state change response message 255 indicates whether rate matching is enabled or disabled. The dynamic rate matching state change response message 255 can be transmitted, for example, using a Radio Resource Control (RRC) message or a Medium Access Control (MAC) Control Element (CE). Alternatively, dynamic rate matching state change response message 255 can be transmitted using Physical Downlink Control Channel (PDCCH) Downlink Control Information (DCI).

If the dynamic rate matching state change response message 255 indicates that the dynamic rate matching state is changed (“Yes” path out of decision step 355), then the second base station 206 transmits (step 465A) and the UE 202 receives (step 365A) data signals using the changed state. If the changed state is disabling rate matching 257, then the second base station 206 transmits (step 465A) and the UE 202 receives (step 365A) data 265A in time-frequency resources carrying control signals transmitted by the first base station 204. The UE 202 can optionally perform interference cancellation 270 (step 370) of the control signals 266 transmitted by the first base station 204 and/or the control signals 267 transmitted by the third base station 208.

If the changed state is enabling rate matching 258, then the second base station 206 transmits (step 455B) and the UE 202 receives (step 356) data 265B with rate matching enabled (step 465B) so that the data 265B is allocated to time-frequency resources avoiding those used by the first base station 204 to carry the control signals.

As shown in FIG. 2C, the first base station 204 can initiate a dynamic rate matching state change. The first base station 204 can determine whether to request a change in the rate matching state based on the impact of interference from the second base station 206. This determination can be based on, for example, the loading of the first base station 204 and its supported UE's reported RSRP/RSRQ/CQI to determine whether the second base station's 206 transmissions are interfering with the first base station's 204 transmissions to its supported UEs. Further, in some situations, the first base station 204 can transmit the control signals using UE-specific Reference Signals (UE-RS) to mitigate interference from the second base station 206.

If the first base station 204 determines 272 that the dynamic rate matching state should be changed (“Yes” path out of decision step 570), then the first base station 204 transmits (step 575) an inter-base station dynamic rate matching state change request message 275 to the second base station 206. The second base station 206 transmits a dynamic rate matching state change request message 280 to the UE 202 indicating that rate matching is enabled and the second base station 206 optionally transmits (step 585) an inter-base station dynamic rate matching state change response message 285 to the first base station 204. The second base station 206 then starts transmitting data 290 to the UE 202 in time-frequency resources based on the changed rate matching state.

The discussion above involves the first base station 204 and the second base station 206 operating using different radio access technologies, and the first base station 204 transmitting control signals in fixed time-frequency resources. The discussion in connection with the first base station 204 also applies to other base stations operating using the same radio access technology as the first base station 204, such as a third base station 208. Thus, FIG. 2A illustrates the UE 202 receiving control signals 224 from the third base station 208, which the UE 202 can use to calculate 230 interference caused by downlink control signals 267 of the third base station 208 to transmissions from the second base station 206. In other words, the processes described in connection with the first base station 204 are equally applicable to the third base station 208. Further, the processes for the first base station 204 and the third base station 208 can be performed together. Thus, for example, the UE can calculate 230 interference caused by downlink transmissions from the first base station 204 and the third base station 208 and then individually determine 235 whether to change the rate matching state relative to either base station. The dynamic rate matching state change request 240 can in this case indicate (e.g., by cell-ID) that rate matching should be disabled with respect to the transmissions by the first base station 204 but should remain enabled with respect to transmissions by the third base station 208. This can occur when the UE 202 is located closer to the third base station 208 than to the first base station 204, and therefore the transmissions by the third base station 208 are more likely to cause interference to signals received by the UE 202. Depending upon configuration, the first base station 204 and the third base station 208 can transmit control signals in the same or in different time-frequency resources.

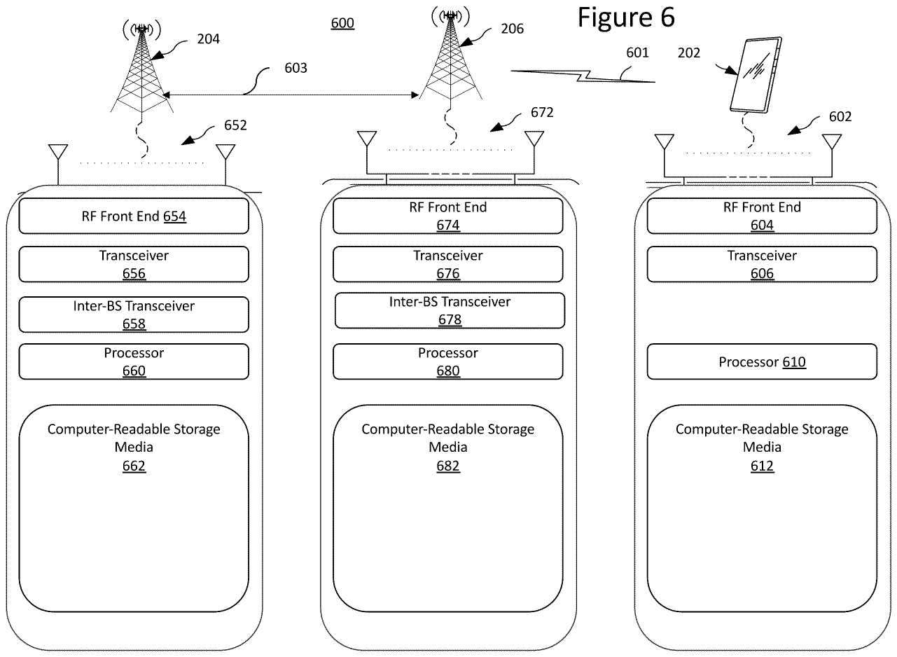

FIG. 6 is a block diagram illustrating software and hardware of a UE 202, first base station 204, and second base station 206 that can implement various aspects of the methods described above. The block diagram 600 illustrates the components of the UE 202 and base stations 204 and 206 relevant for this discussion and it will be recognized that the UE 202 and base stations 204 and 206 can include other software and hardware components. Signaling arrow 601 generally represents both uplink and downlink signals transmitted by UE 202 and second base station 206. Double-ended arrow 603 generally represents a bi-directional wired and/or wireless communication path between the first base station 204 and the second base station 206 sometimes called an Xn interface. Further, the term “base station” can be interchangeable herein with eNB, gNB, master node, and secondary node, depending on which radio technology deployment is used and which embodiments described herein are implemented.

The UE 202 includes antennas 602, a radio frequency (RF) front end 604, and at least one RF transceiver 606. The antennas 602 and the RF front end 604 can be tuned to one or more frequency bands, e.g., as may be defined by 3GPP LTE, 5G NR, and 6G communication standards and implemented by the at least one transceiver 606. The antennas 602, RF front end 604, and at least one RF transceiver 606 can be configured to support beamforming.

The UE 202 also includes a processor 610 and computer-readable storage media (CRM) 612. The processor 610 can include one or more single or multiple-core processors, and the CRM 612 excludes propagating signals and includes any suitable memory/storage. For example, memory/storage can include random-access memory (RAM), static RAM (SRAM), dynamic RAM (DRAM), non-volatile RAM (NVRAM), read-only memory (ROM), and/or flash memory useable to store device data of the UE 202.

The device data of the UE stores instructions executable by the processor 610 to facilitate user-plane communication, control-plane signaling, and user interaction with the second base station 206.

The first base station 204 is illustrated as a single network node (e.g., a gNB or an eNB). However, the functionality of the first base station 204 may be distributed across multiple entities such as a central unit (CU), distributed unit (DU), and/or radio unit (RU). The first base station 204 includes antennas 652, an RF front end 654, and at least one RF transceiver 656. The antennas 652 and the RF front end 654 can be tuned to one or more frequency bands, e.g., as may be defined by 3GPP LTE, 5G NR, and 6G communication standards and implemented by the transceiver 656. The antennas 652, RF front end 654, and RF transceiver 656 can be configured to support beamforming. The first base station 204 also includes an inter-base station transceiver 658 for bi-directional communications with the second base station 206.

The first base station 204 includes at least one processor 660 and computer-readable storage media (CRM) 662. The at least one processor 660 can include single or multiple-core processors, and the CRM 662 excludes propagating signals and includes any suitable memory/storage. For example, memory/storage can include random-access memory (RAM), static RAM (SRAM), dynamic RAM (DRAM), non-volatile RAM (NVRAM), read-only memory (ROM), and/or flash memory useable to store device data of the first base station 204. The device data of the first base station 204 includes network scheduling data, radio resource management data, applications, and/or an operating system of the first base station 204, which are executable by the at least one processor 660 to enable wireless communication 601 with the UEs. The third base station 208 can be configured similarly to the first base station 204.

The second base station 206 is illustrated as a single network node (e.g., a gNB or an eNB). However, the functionality of the second base station 206 may be distributed across multiple entities as described earlier with respect to the first base station 204. The second base station 206 includes antennas 672, an RF front end 674, and at least one RF transceiver 676. The antennas 672 and the RF front end 674 can be tuned to one or more frequency bands, e.g., as may be defined by 3GPP LTE, 5G NR, and 6G communication standards and implemented by the transceiver 676. The antennas 672, RF front end 674, and RF transceiver 676 can be configured to support beamforming. The second base station 206 also includes an inter-base station transceiver 678 for bi-directional communications with the first base station 204.

The second base station 206 includes at least one processor 680 and computer-readable storage media (CRM) 682. The at least one processor 680 can include single or multiple-core processors, and the CRM 682 excludes propagating signals and includes any suitable memory/storage. For example, memory/storage can include random-access memory (RAM), static RAM (SRAM), dynamic RAM (DRAM), non-volatile RAM (NVRAM), read-only memory (ROM), and/or flash memory useable to store device data of the second base station 206. The device data of the second base station 206 includes network scheduling data, radio resource management data, applications, and/or an operating system of the second base station 206, which are executable by the at least one processor 680 to enable wireless communication 601 with the UE 202.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

In concluding, it is noted that references to the singular (e.g., “a” or “an”, “the”) should include the plural unless clearly indicated otherwise.

The term “and/or” is intended to include any combination of the terms “and” and “or.” For example, “A and/or B” may be understood to mean any combination including “A, B, or A and B.” The terms “and” and “or” may be used in the conjunctive or disjunctive sense and may be understood to be equivalent to “and/or.” The construction “at least one of A or B” (e.g., A, B, or C) should be interpreted as any combination including A and/or B, including “A,” “B,” “A+A,” “B+B,” and “A+B.” The same reference numbers in different drawings identify the same or similar elements.

Although the signaling diagrams and flow charts illustrate messages being sent and steps being performed in a particular order, these messages and steps can be performed in a different order than illustrated. For example, referring to FIG. 2C, the second base station 206 can transmit the inter-base station dynamic rate matching state change response message 285 to the first base station 204 at the same time or prior to the second base station 206 transmitting the dynamic rate matching state change request message 280 to the UE 202. Further, the steps need not be considered as distinct steps and can, in some implementations, be combined. For example, referring to FIG. 3, the UE 202 can determine (step 335) whether to request a dynamic rate matching state change as part of the calculation (step 330) of interference caused by downlink control signals transmitted by the first base station 204.

Reference throughout the specification to “one embodiment” or “an embodiment” means that a particular feature, structure or characteristic described in connection with an embodiment is included in at least one embodiment of the present invention. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Note that numerical adjectives “first”, “second”, and “third” do not imply any order (are not ordinals) but are markers to distinguish separate instances of similar elements.

While various aspects and embodiments have been disclosed herein, other aspects and embodiments will be apparent to those skilled in the art. The various aspects and embodiments disclosed herein are for purposes of illustration and are not intended to be limiting.

1-15. (canceled)

16. A method for wireless communication performed at a user equipment, the method comprising:
calculating an amount of interference caused by a downlink control signal, transmitted by a first base station in a first fixed time-frequency resource, to a downlink transmission from a second base station, the first base station using a first radio access technology, and the second base station using a different, second radio access technology;
determining, based on the calculating, whether to change a dynamic rate matching state;
transmitting, to the second base station based on the calculating, a first dynamic rate matching state change request message when the amount of interference meets an interference threshold criterion;
receiving a first dynamic rate matching state change response message from the second base station; and
receiving first data signals from the second base station based on the first dynamic rate matching state change response message.

17. The method of claim 16, further comprising:
transmitting, to the second base station prior to the calculating, a message indicating that the user equipment supports dynamic spectrum sharing with dynamic rate matching.

18. The method of claim 16, wherein the calculating the amount of interference comprises:
measuring, in the first fixed time-frequency resource, the downlink control signal transmitted by the first base station.

19. The method of claim 16, wherein
the first dynamic rate matching state change request message indicates that rate matching should be disabled, and
the receiving the first data signals comprises receiving the first data signals in the first fixed time-frequency resource.

20. The method of claim 16, wherein the downlink control signal transmitted by the first base station in the first fixed time-frequency resource is a cell-specific reference signal.

21. The method of claim 16, further comprising:
measuring an amount of interference caused by a second downlink control signal, transmitted by a third base station in a second fixed time-frequency resource, to the downlink transmission from the second base station, the third base station using the first radio access technology;
transmitting, to the second base station based on the measuring, a second dynamic rate matching state change message;
receiving a second dynamic rate matching state change response message from the second base station; and
receiving second data signals from the second base station based on the second dynamic rate matching state change response message.

22. The method of claim 21, wherein the first fixed time-frequency resource and the second fixed time-frequency resource are different.

23. The method of claim 16, further comprising:
performing interference cancelation of the downlink control signal transmitted by the first base station while receiving the first data signals from the second base station.

24. The method of claim 16, further comprising:
transmitting, to the second base station, a second dynamic rate matching state change request message.

25. A method for a second base station, the method comprising:
receiving a first dynamic rate matching state change request message, from a user equipment, for changing a rate matching state to a changed rate matching state;
transmitting a first dynamic rate matching state change response message, to the user equipment, including the changed rate matching state; and
transmitting first data signals to the user equipment in time-frequency resources based on the changed rate matching state of the first dynamic rate matching state change response message.

26. The method of claim 25, further comprising:
transmitting an inter-base station dynamic rate matching state change request message to a first base station, wherein the first and second base stations operate using different radio access technologies; and
receiving an inter-base station dynamic rate matching state change response message from the first base station.

27. The method of claim 25, further comprising:
receiving, prior to the receiving the first dynamic rate matching state change request from the user equipment, a message indicating that the user equipment supports dynamic spectrum sharing with dynamic rate matching.

28. The method of claim 25, further comprising:
receiving, subsequent to the transmitting the first data signals to the user equipment, a second dynamic rate matching state change request message from the user equipment;
transmitting a second dynamic rate matching change response message to the user equipment; and
transmitting second data signals to the user equipment based on the second dynamic rate matching change response message.

29. The method of claim 25, wherein the first dynamic rate matching state change response message indicates that rate matching is disabled, the method further comprising:
receiving, subsequent to the transmitting the first data signals to the user equipment, an inter-base station dynamic rate matching state change request from the first base station;
transmitting, to the user equipment, a second dynamic rate matching state change response message indicating that rate matching is enabled; and
transmitting second data signals to the user equipment that avoid the time-frequency resources.

30. An apparatus for wireless communication, comprising:
a wireless transceiver; and
a processor coupled to the wireless transceiver and configured to:
calculate an amount of interference caused by a downlink control signal, transmitted by a first base station in a first fixed time-frequency resource, to a downlink transmission from a second base station, the first base station using a first radio access technology, and the second base station using a different, second radio access technology,
determine, based on the calculation, whether to change a dynamic rate matching state,
transmit, to the second base station based on the calculation, a first dynamic rate matching state change request message when the amount of interference meets an interference threshold criterion,
receive a first dynamic rate matching state change response message from the second base station, and
receive first data signals from the second base station based on the first dynamic rate matching state change response message.

31. The apparatus of claim 30, wherein the processor is further configured to:
transmit, to the second base station prior to the calculate, a message indicating that the apparatus supports dynamic spectrum sharing with dynamic rate matching.

32. The apparatus of claim 30, wherein the processor is further configured to:
measure, in the first fixed time-frequency resource, the downlink control signal transmitted by the first base station.

33. The apparatus of claim 30, wherein:
the first dynamic rate matching state change request message indicates that rate matching should be disabled, and
the processor configured to receive the first data signals is further configured to receive the first data signals in the first fixed time-frequency resource.

34. The apparatus of claim 30, wherein the downlink control signal transmitted by the first base station in the first fixed time-frequency resource is a cell-specific reference signal.

35. The apparatus of claim 30, wherein the processor is further configured to:
measure an amount of interference caused by a second downlink control signal, transmitted by a third base station in a second fixed time-frequency resource, to the downlink transmission from the second base station, the third base station using the first radio access technology,
transmit, to the second base station based on the measure, a second dynamic rate matching state change message,
receive a second dynamic rate matching state change response message from the second base station, and
receive second data signals from the second base station based on the second dynamic rate matching state change response message.
